(19) United States
(12) Patent Application Publication
(10) Pub. No.: US 2026/0358285 A1
(43) Pub. Date: Nov. 12, 2026

(54) AUTOMATED SYSTEM AND METHOD FOR ELECTROCHEMICAL CHARACTERIZATION

(71) Applicant: KOREA INSTITUTE OF SCIENCE AND TECHNOLOGY, Seoul (KR)

(72) Inventors: Sang Soo HAN, Seoul (KR); Daeho KIM, Seoul (KR); Jong Min KIM, Seoul (KR); Seung Yong LEE, Seoul (KR)

(73) Assignee: KOREA INSTITUTE OF SCIENCE AND TECHNOLOGY, Seoul (KR)

(21) Appl. No.: 19/358,480

(22) Filed: Oct. 15, 2025

(30) Foreign Application Priority Data
May 12, 2025 (KR) 10-2025-0061171

(51) Int. Cl. G01N 27/30; G01N 27/38; G01N 35/00

(52) U.S. Cl. CPC G01N 27/301; G01N 27/38; G01N 35/00722; G01N 35/0099

(57) ABSTRACT

An automated system for electrochemical property evaluation, according to some embodiments, may include: a robot module configured to transfer a catalyst sample and to aspirate and apply a catalyst droplet; an RDE module including a rotating disk electrode (RDE) and an RDE driving unit configured to move the RDE; an inspection unit configured to visually verify a state of the catalyst droplet applied onto an electrode surface of the RDE; and a control device configured to control the robot module, the RDE module, and the inspection unit, by a Python-based program, in which the control device may be configured to: process an image captured by the inspection unit to determine whether applying of the catalyst droplet is successful; and when the applying fails, control the robot module and the RDE module to reattempt the applying of the catalyst droplet.

### CROSS REFERENCE TO RELATED APPLICATION

The present application claims priority to Korean Patent Application No. 10-2025-0061171, filed May 12, 2025, the entire contents of which are hereby incorporated by this reference.

### BACKGROUND OF THE INVENTION

### Field of the Invention

The present invention relates to an automated system and method for electrochemical characterization, and more specifically, relates to a rotating disk electrode (RDE)-based automated system and method for electrochemical characterization, which is capable of precisely analyzing electrochemical properties of a catalyst by automating steps of electrode preparation, cell preparation, electrochemical measurement, and cleaning.

The present invention was conducted with the support of the following national research and development programs.

National research and development program 1 that supported the present invention
Project unique number: 2710014985
Project number: 2022M3H4A7046278
Name of department: Ministry of Science and ICT
Name of project management (specialized) institution: National Research Foundation of Korea
Name of research program: Development of nanomaterial technology
Name of research project: Development of AI smart laboratory for synthesis of water electrolysis catalyst and nanoparticles for display
Name of project performing institution: Korea Institute of Science and Technology
Research period: Jan. 1, 2024 to Dec. 31, 2024

National research and development program 2 that supported the present invention
Project unique number: 2710068719
Project number: 00450102
Name of department: Ministry of Science and ICT
Name of project management (specialized) institution: National Research Foundation of Korea
Name of research program: Nano·Material Technology Development (R&D)
Name of research project: Super-catalyst data HUB for green hydrogen production
Name of project performing institution: Korea Institute of Science and Technology
Research period: Jan. 1, 2025 to Dec. 31, 2025

### Description of Related Art

Recently, research on an autonomous laboratory for developing materials by minimizing human intervention has been actively conducted. Accordingly, although various automated equipment for material development is being developed, automation for measuring equipment that analyzes the properties of substances is relatively insufficient compared to synthesizing equipment that develops substances. Limitations of measuring equipment result in limitations of developed materials, and thus, development of measuring equipment for developing various materials is required.

An electrochemical measurement method is widely used at a laboratory level, and in many cases, the researcher directly performs the analysis without a professional operator. Due to this, reproducibility of the analysis is not secured depending on the proficiency of the researcher, and there is a problem in that analysis results published in papers are difficult to reproduce in other laboratories. That is, there is a problem in that the reproducibility is low, and the same results are difficult to obtain in other laboratories. Meanwhile, in order to analyze the physical properties of a catalyst through electrochemical measurement, an electrode needs to be manufactured using the catalyst. In case of a rotating disk electrode (hereinafter, referred to as “RDE”), an electrode is manufactured by applying the catalyst onto an electrode surface, and elements such as a method of dropping a catalyst droplet onto the electrode surface, a method of drying the electrode surface, and the like affect analysis of catalyst properties. However, since a standardized and normalized electrode manufacturing method does not exist, each laboratory uses a different manufacturing method to perform analysis, and there are limitations for researchers to control various variables.

In order to solve such problems, development of a system that may minimize intervention of a researcher and may obtain reproducible results by automating an entire process required for electrochemical characterization (property evaluation) is required.

### SUMMARY OF THE INVENTION

One of the technical objects that the present invention intends to solve is to provide a system capable of consistently analyzing electrochemical properties of a catalyst without researcher intervention by automating each equipment used in electrochemical measurement.

In addition, one of the technical objects that the present invention intends to solve is to provide a system capable of securing reproducibility of measurement results by automating all of the steps of electrode preparation, cell preparation, electrochemical measurement, and cleaning of a cell and an electrode.

In addition, one of the technical objects that the present invention intends to solve is to provide a system capable of automatically reattempting when an applying failure occurs, by visually verifying a catalyst applying state on an electrode surface.

The technical objects to be solved by the present invention are not limited to the objects described above, and other technical objects not mentioned will be clearly understood by those of ordinary skill in the art from the present specification and the accompanying drawings.

To achieve the aforementioned technical objects, there is provided an automated system for electrochemical property evaluation, for analyzing electrochemical properties of a catalyst, according to some embodiments of the present invention. The automated system may comprise: a robot module configured to transfer a catalyst sample and to aspirate and apply a catalyst droplet; an RDE module including a rotating disk electrode (RDE) and an RDE driving unit configured to move the RDE; an inspection unit configured to visually verify a state of the catalyst droplet applied onto an electrode surface of the RDE; and a control device configured to control the robot module, the RDE module, and the inspection unit, by a Python-based program, in which the control device may be configured to: process an image captured by the inspection unit to determine whether applying of the catalyst droplet is successful; and when the applying fails, control the robot module and the RDE module to reattempt the applying of the catalyst droplet.

According to some embodiments, the RDE driving unit may comprise a three-axis actuator configured to move the RDE in X-axis, Y-axis, and rotation (R) axis directions.

According to some embodiments, the automated system may further comprises: a frame on which the robot module, the RDE module, and the inspection unit are installed, in which the frame may be configured such that additional components are installed in parallel.

According to some embodiments, the RDE driving unit may be configured to move the RDE to a plurality of specific positions corresponding to each of: a pipette included in the robot module; and a cell, the inspection unit, a drying unit, a moisture supply unit, a first cleaning unit, and a second cleaning unit, which are disposed on the frame.

According to some embodiments, a position corresponding to the pipette among the specific positions may be a position where the electrode surface of the RDE is disposed to face the pipette, and the catalyst droplet is applied from the pipette, a position corresponding to the cell among the specific positions may be a position where the RDE is inserted into an interior of the cell and an electrochemical measurement is performed, a position corresponding to the inspection unit among the specific positions may be a position where the electrode surface of the RDE is disposed to face a microscope of the inspection unit, and an applied state of the catalyst droplet is captured, and a position corresponding to the drying unit among the specific positions may be a position where the electrode surface of the RDE is disposed to face an IR lamp of the drying unit and the catalyst droplet is dried.

According to some embodiments, a position corresponding to the moisture supply unit among the specific positions may be a position where the electrode surface of the RDE is disposed to face the moisture supply unit and moisture is supplied to the dried electrode surface, a position corresponding to the first cleaning unit among the specific positions may be a position where the electrode surface of the RDE is disposed to come into contact with a polishing pad of the first cleaning unit and the electrode surface is mechanically polished, and a position corresponding to the second cleaning unit among the specific positions may be a position where the RDE is inserted into a container filled with ethanol in the second cleaning unit and ultrasonic cleaning is performed.

According to some embodiments, the control device may be configured to control the RDE driving unit by a Python-based program so as to sequentially move the RDE between the specific positions.

According to some embodiments, the control device may be configured to detect an electrode boundary, an inner electrode surface, and a catalyst droplet boundary between the electrode boundary and the inner electrode surface in an image captured by the inspection unit, and to determine whether the catalyst droplet is uniformly applied within the inner electrode surface.

According to some embodiments, the RDE module may further comprise: a cell in which an electrolyte is accommodated and in which the RDE, a counter electrode, and a reference electrode are disposed; a cell supply unit configured to supply the electrolyte, deionized water, and gas to the cell; and a cell discharge unit configured to discharge a liquid or gas in an interior of the cell.

According to some embodiments, the RDE module may further comprise: a drying unit configured to dry the catalyst droplet applied onto the electrode surface of the RDE; a moisture supply unit configured to supply moisture to the dried electrode surface; a first cleaning unit configured to perform first cleaning by polishing the electrode surface of the RDE; and a second cleaning unit configured to perform a second cleaning of the RDE with ultrasonic waves.

In addition, there is provided a method for measuring electrochemical properties of a catalyst, according to some embodiments. The method may comprise: an electrode preparation step in which a robot arm transfers a catalyst sample accommodated in a sample holder to a sample seating portion, and aspirates a catalyst droplet within the catalyst sample via a pipette disposed on the robot arm, and a rotating disk electrode (RDE) is moved by an RDE driving unit to a position facing the pipette so that the pipette applies the catalyst droplet onto an electrode surface of the RDE; a droplet application verification step in which the RDE driving unit moves the RDE to a position facing an inspection unit, the inspection unit captures an image of the catalyst droplet applied to the electrode surface of the RDE, and determines whether the catalyst droplet is normally applied from the captured image; an electrode surface drying step in which the RDE driving unit moves the RDE to a position facing a drying unit, and the drying unit dries the catalyst droplet applied onto the electrode surface of the RDE; a moisture supplying step in which the RDE driving unit moves the RDE to a position facing a moisture supply unit, and the moisture supply unit supplies moisture to the dried electrode surface of the RDE; a measurement step in which the RDE driving unit moves the RDE to a position inserted into an interior of a cell, and electrochemical measurement of the catalyst is performed using a current measuring device while rotating the RDE; and a cleaning step in which the RDE driving unit moves the RDE to positions respectively corresponding to a first cleaning unit and a second cleaning unit, the first cleaning unit mechanically polishes the electrode surface of the RDE, and the second cleaning unit cleans the electrode surface of the RDE with ultrasonic waves.

According to some embodiments, the droplet application verification step may comprise: detecting an electrode boundary from the captured image; detecting an inner electrode surface inside the electrode boundary; verifying whether a droplet boundary exists between the electrode boundary and the inner electrode surface; and determining whether the droplet application succeeds or fails based on positional relationships among the electrode boundary, inner electrode surface, and droplet boundary.

According to some embodiments, when a droplet application failure is determined in the droplet application verification step, the RDE driving unit may move the RDE to the first cleaning unit or the second cleaning unit, and the electrode preparation step may be performed again after cleaning.

According to some embodiments, the method may further comprise: prior to the measurement step, an electrolyte supply step of supplying an electrolyte to the cell using a first pump and an argon gas supply start step of supplying argon gas into the interior of the cell using a flow controller.

According to some embodiments, the method may further comprise: after the measurement step, an argon gas supply stop step of stopping a supply of argon gas through a flow controller; an electrolyte removal step of removing the electrolyte in the interior of the cell through a waste liquid outlet portion; a distilled water supply step of supplying deionized water into the interior of the cell using a second pump; and a distilled water discard step of discarding the distilled water in the interior of the cell through the waste liquid outlet portion.

According to some embodiments, the robot arm, the RDE driving unit, the inspection unit, the drying unit, the moisture supply unit, the first cleaning unit, and the second cleaning unit may be communicably connected to a control device, and may be controlled by a Python-based program.

Other detailed matters of the exemplary embodiment are included in the detailed description and the drawings.

According to embodiments of the present disclosure, by automating each equipment used in electrochemical measurement, electrochemical properties of a catalyst can be consistently analyzed without researcher intervention.

In addition, according to embodiments of the present disclosure, reproducibility of measurement results can be secured by automating all of the steps of electrode preparation, cell preparation, electrochemical measurement, and cleaning of a cell and an electrode.

In addition, according to embodiments of the present disclosure, high scalability capable of adding new equipment or changing a process sequence as needed by connecting different equipment in parallel based on Python can be provided.

The effects of the present invention are not limited to the effects described above, and other effects, which are not mentioned above will be clearly understood by those of ordinary skill in the art from the description of the claims.

### BRIEF DESCRIPTION OF THE DRAWINGS

FIG. 1 is a block diagram schematically illustrating an automated system for electrochemical property evaluation according to an embodiment of the present invention.

FIG. 2 is a perspective view schematically illustrating the automated device for electrochemical property evaluation in FIG. 1.

FIG. 3 is a side view schematically illustrating the automated device for electrochemical property evaluation in FIG. 1.

FIG. 4 is a perspective view schematically illustrating a frame in FIG. 3.

FIG. 5 is a partial perspective view schematically illustrating a robot module in FIG. 3.

FIG. 6 is a view schematically illustrating an enlarged state of portion A in FIG. 5.

FIG. 7 is a partial perspective view schematically illustrating an RDE and an RDE driving unit in FIG. 3.

FIG. 8 is a side view schematically illustrating a path along which the RDE driving unit in FIG. 3 moves the RDE.

FIG. 9 is a schematic view schematically illustrating a cell, a cell supply unit, and a cell discharge unit in FIG. 3.

FIG. 10 is a partial perspective view schematically illustrating the cell, the cell supply unit, and the cell discharge unit in FIG. 3.

FIG. 11 is a flowchart of a method for measuring electrochemical properties of a catalyst using the automated system for electrochemical property evaluation in FIG. 1.

FIG. 12 is a view schematically illustrating a state in which a catalyst droplet application step is performed.

FIG. 13 is a view schematically illustrating a state in which a droplet application verification step is performed.

FIG. 14 is a flowchart illustrating a detailed sequence of image processing and droplet application determination performed in the droplet application verification step.

FIG. 15 is a view schematically illustrating an electrode boundary, an inner electrode surface, and a droplet boundary between the electrode boundary and the inner electrode surface in FIG. 14.

FIG. 16 is views schematically illustrating exemplary states of droplet application success and failure in the droplet application verification step.

FIG. 17 is a view schematically illustrating a state in which an electrode surface drying step is performed.

FIG. 18 is a view schematically illustrating a state in which a moisture supplying step is performed.

FIG. 19 is a view schematically illustrating a state in which a measurement step is performed.

FIG. 20 is a view schematically illustrating a state in which an electrode surface polishing step is performed.

FIG. 21 is a view schematically illustrating a state in which an ultrasonic cleaning step is performed.

FIG. 22 is a graph evaluating reproducibility based on data deviation when electrochemical properties of a catalyst are measured using the automated system for electrochemical property evaluation in FIG. 1.

FIG. 23 is an enlarged view of portion B in FIG. 22.

### DETAILED DESCRIPTION OF THE INVENTION

Hereinafter, embodiments of the present invention described below may be modified and implemented in various forms, and the technical teachings of the present invention are not limited to the embodiments described below. The terms used in the embodiments of the present invention have been selected, unless otherwise specifically defined in this specification by the applicant, by selecting general terms that are currently widely used while considering the functions in the invention. However, such terms may vary depending on the intention of a person skilled in the art to which the present invention pertains, court precedents, the emergence of new technology, or the like. In addition, the terms or words used in the present specification and claims shall not be construed as being limited to their conventional or dictionary definitions, and shall be interpreted as including meanings and concepts that conform to the technical teachings of the present invention.

In the present specification, unless otherwise explicitly stated to the contrary, the expression that a certain component “includes” something shall be understood to imply not the exclusion of other components, but that it may further include other components. Specifically, terms "comprises," "comprising," "includes," "including," "containing," "has," "having" or other variations thereof shall be interpreted to denote the inclusion of features, numbers, steps, operations, components, parts, or combinations thereof as described in the present specification, and shall not be interpreted to preclude the possibility of the presence or addition of one or more other features, numbers, steps, operations, components, parts, or combinations thereof.

In the present specification, singular expressions shall be understood to include plural expressions unless clearly stated otherwise from the context. In addition, terms such as “first” and “second” may be used to describe various components, but the components shall not be limited by the terms, and the terms are only used to distinguish one component from another. A first component may be named as a second component within the scope belonging to the technical teachings of the present invention, and similarly, the second component may be named as the first component. In addition, in the drawings, shapes ,sizes, etc. of components may be exaggerated to emphasize clear description. In addition, expressions such as “upper side,” “lower side,” “upper portion,” “lower portion,” “side surface,” “upper surface,” and “lower surface” described below are based on the directions illustrated in the drawings, and it is pre-disclosed that such expressions may vary when the orientation of the corresponding object is changed. Further, in the present specification, the terms “module,” “part,” or “unit” may denote a unit composed of a single element, or a unit expressed as a combination or set of a plurality of elements.

Hereinafter, embodiments of the present invention will be described in detail with reference to the drawings attached so that a person having ordinary skill in the technical field to which the present invention pertains may easily carry out the present invention.

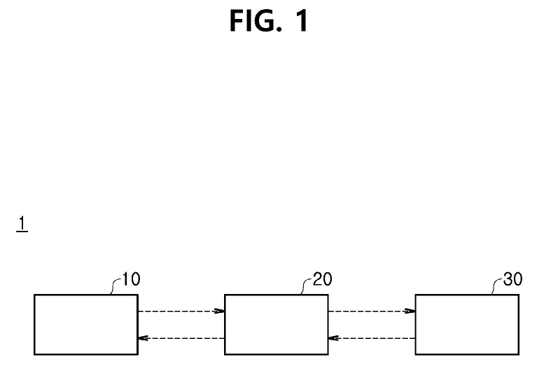

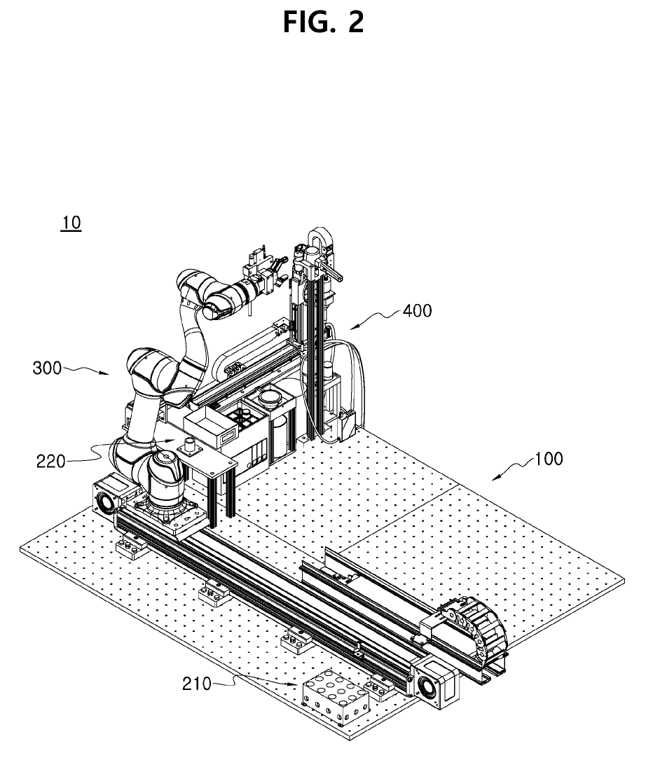

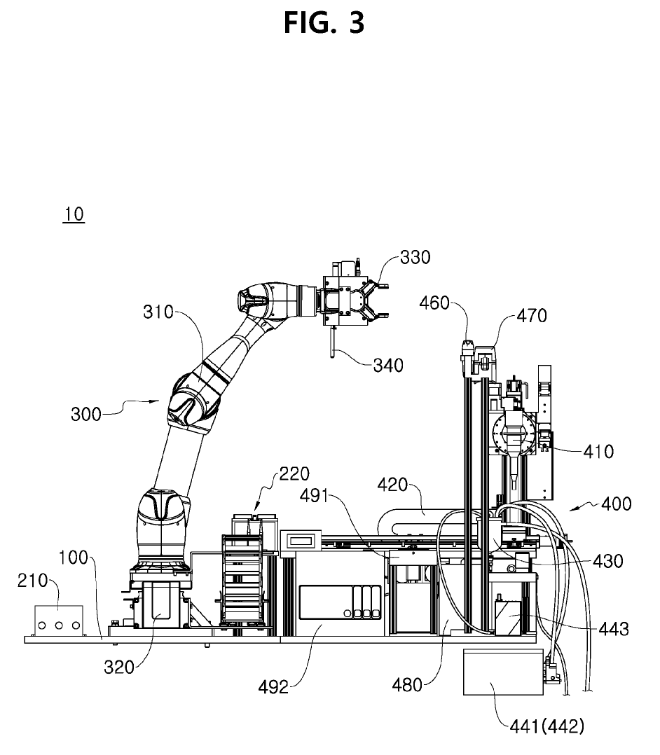

FIG. 1 is a block diagram schematically illustrating an automated system for electrochemical property evaluation according to an embodiment of the present invention. FIG. 2 is a perspective view schematically illustrating the automated device for electrochemical property evaluation in FIG. 1. FIG. 3 is a side view schematically illustrating the automated device for electrochemical property evaluation in FIG. 1.

With reference to FIGS. 1-3, an automated system 1 for electrochemical property evaluation according to some embodiments may analyze physical properties of a catalyst. For example, the automated system 1 for electrochemical property evaluation may be used to analyze electrochemical properties of a catalyst.

In some embodiments, the automated system 1 for electrochemical property evaluation may include an automated device 10 for electrochemical property evaluation, a current measuring device 20, and a control device 30. The automated device 10 for electrochemical property evaluation, the current measuring device 20, and the control device 30 may each be wired or wirelessly interconnected and may operate as an integrated system.

The automated device 10 for electrochemical property evaluation according to some embodiments may automatically perform steps of cell preparation, electrode preparation, measurement, and cleaning to analyze electrochemical properties of a catalyst. The automated device 10 for electrochemical property evaluation may have a modularized scalable structure. Specifically, the automated device 10 for electrochemical property evaluation may provide flexibility to variably change a process sequence, for example, by a method of adding new equipment as needed, since respective hardware devices are configured as an independent module, or the like. Such a parallelized equipment configuration may contribute to scalability of the system.

In addition, the automated device 10 for electrochemical property evaluation may be controlled by a Python-based program and may operate automatically according to a set protocol. Communicable equipment may be controlled by Python code based on a corresponding development package, and non-communicable equipment may be controlled by Python code through an automated power box. A detailed description of the automated device 10 for electrochemical property evaluation will be described later.

The current measuring device 20 according to some embodiments may be a device that precisely controls a potential (voltage) applied to an electrode and measures a current corresponding thereto. For example, the current measuring device 20 may include a potentiostat. In addition, the current measuring device 20 may control at least one RDE measuring system (e.g., an RDE rotor described later, etc.) simultaneously, with a structure having multiple slots. The current measuring device 20 may be controlled by Python code using a development package, and may operate based on measurement parameters stored in JSON format.

In addition, the current measuring device 20 may be connected to and operate with an RDE rotor that rotates an RDE 410, described later, at a specific speed. The current measuring device 20 applies a variable voltage to the RDE 410 and measures a current flowing through a catalyst to be analyzed, and an RDE rotor may be independently controlled to consistently rotate the RDE 410 at a set RPM. In this process, potential-current relation data measured is stored in JSON format and is used for analysis of electrochemical properties of a catalyst.

The control device 30 according to some embodiments may be a central control device that manages the entire automated system 1 for electrochemical property evaluation. For example, the control device 30 may be implemented as a computing device such as a PC and the like. In the control device 30, an overall management and measurement protocol is stored as Python-based code, and the automated device 10 for electrochemical property evaluation that is automated though this is controlled to operate in a consistent manner. Data management and measurement results are stored in a standardized data structure of JSON type, and data consistency and interoperability are ensured. Each configuration of the automated device 10 for electrochemical property evaluation to be described later (e.g., a robot module 300, an RDE module 400, etc.) and the current measuring device 20 are integrally controlled, so that an entire process such as cell preparation, electrode preparation, measurement, cleaning, and the like is automatically sequentially performed.

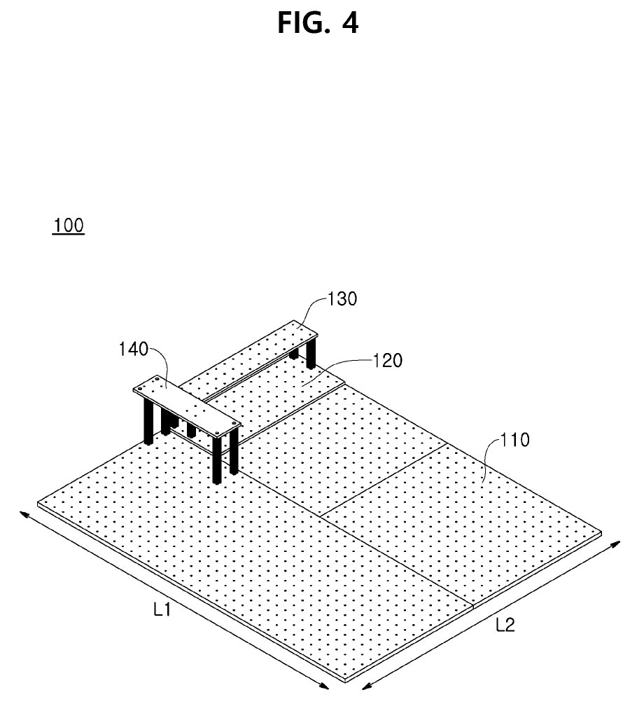

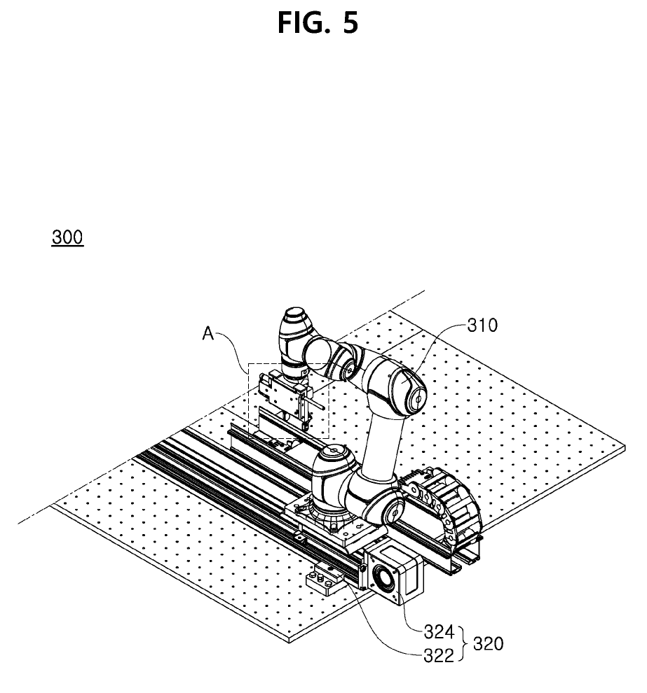

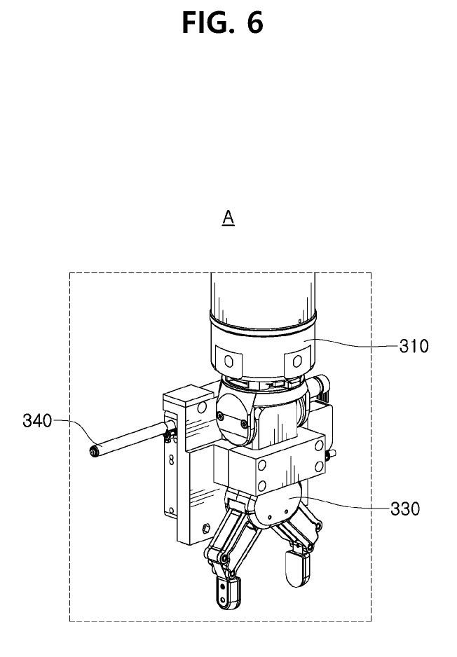

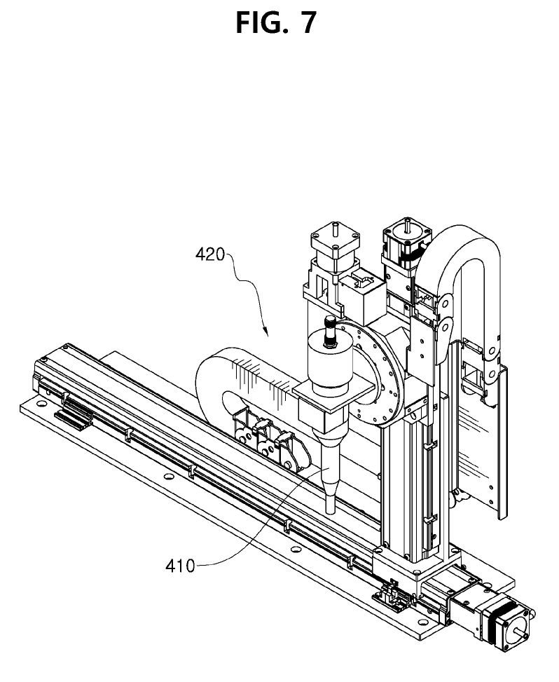

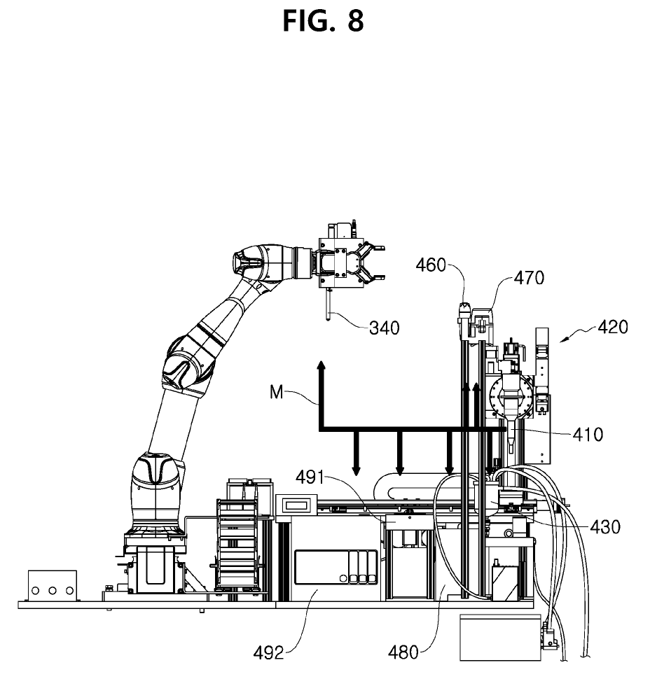

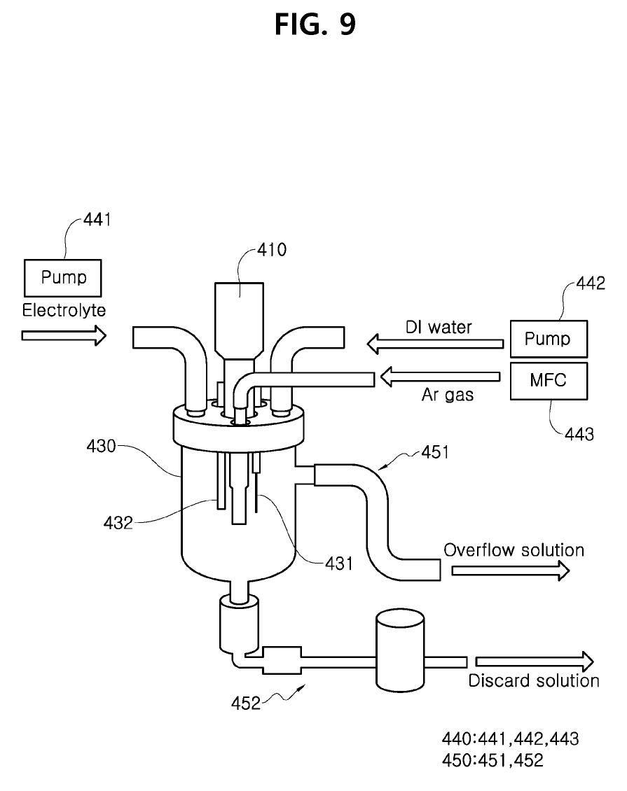

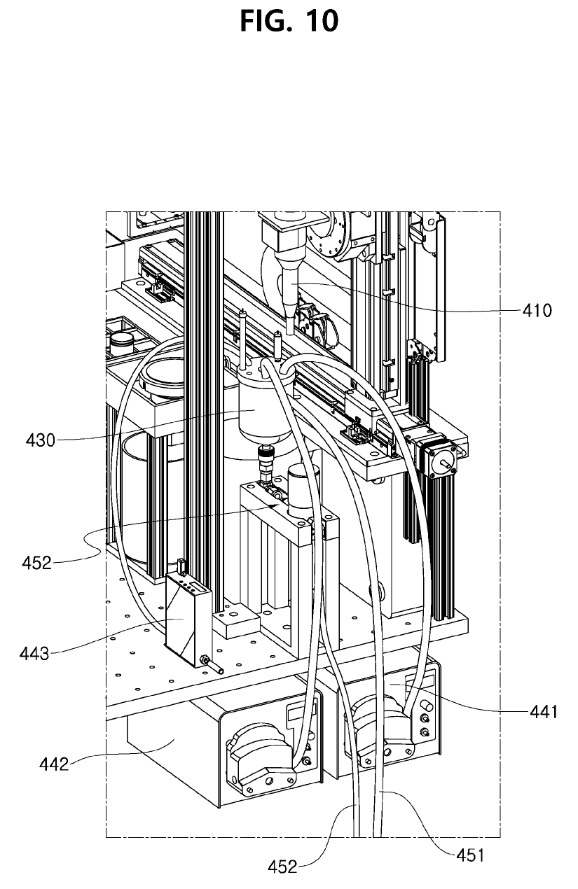

FIG. 4 is a perspective view schematically illustrating a frame in FIG. 3. FIG. 5 is a partial perspective view schematically illustrating a robot module in FIG. 3. FIG. 6 is a view schematically illustrating an enlarged state of portion A in FIG. 5. FIG. 7 is a partial perspective view schematically illustrating an RDE and an RDE driving unit in FIG. 3. FIG. 8 is a side view schematically illustrating a path along which the RDE driving unit in FIG. 3 moves the RDE. FIG. 9 is a schematic view schematically illustrating a cell, a cell supply unit, and a cell discharge unit in FIG. 3. FIG. 10 is a partial perspective view schematically illustrating the cell, the cell supply unit, and the cell discharge unit in FIG. 3.

Hereinafter, with reference to FIGS. 1-10, the automated device 10 for electrochemical property evaluation according to some embodiments of the present invention will be described in detail.

The automated device 10 for electrochemical property evaluation according to some embodiments may include a frame 100, a robot module 300, and an RDE module 400. As described above, the automated device 10 for electrochemical property evaluation may be configured in a parallel manner such that new equipment may be added, omitted, or changed as needed.

The frame 100 according to some embodiments may be a structural skeleton of the automated device 10 for electrochemical property evaluation, and may provide a space in which each configuration of the automated device 10 for electrochemical property evaluation may be stably seated and installed at an accurate position. The frame 100 may support a total weight of each configuration, minimize vibration, and maintain precise positional relationships among respective modules.

The frame 100 according to some embodiments may include a main frame 110, a first frame 120, a second frame 130, and a third frame 140. As illustrated in FIG. 4, the main frame 110 may be formed in a substantially rectangular shape, and a length of one side L1 may be 1800 mm, and a length of another side L2 orthogonal thereto may be 1500 mm. On an upper surface of the main frame 110, 6 mm perforations may be provided at 50 mm intervals, and may be designed to fix various equipment at accurate positions. However, a form and a size of the main frame 110 may be variously changed according to design conditions. On the main frame 110, the first frame 120, the second frame 130, and the third frame 140 may be positioned.

The first frame 120 according to some embodiments may be positioned at a corner portion of the main frame 110. The first frame 120 may be manufactured using an aluminum profile, and has high strength and proper lightweightness. The first frame 120 may form a lower end portion of the system and may support various components and modules. A size of the first frame 120 may be designed to secure a space of 300 mm × 700 mm. In addition, the second frame 130 may be positioned to be spaced a predetermined distance above the first frame 120. The second frame 130 provides a working space where main components such as the robot module 300 or the RDE module 400, which will be described later, are installed. A size of the second frame 130 may be designed to secure a space of 150 mm × 700 mm. In addition, the third frame 140 may be positioned to be in contact with one side of the second frame 130, and a lengthwise direction thereof may be orthogonal to the second frame 130 when viewed from above. In addition, the third frame 140 may provide an auxiliary working space in which a sample seating portion 220, which will be described later, is positioned, and may be designed to have a structure in which a robot arm 310 may access and process a sample.

Meanwhile, upper surfaces of the second frame 130 and the third frame 140 may be disposed to have a substantially identical vertical level. Such an identical level structure allows the robot arm 310 to smoothly move between the two frames and perform tasks.

In some embodiments, the main frame 110 may function as a so-called table, the first frame 120 may function as a lower plate of the table, the second frame 130 may function as an upper plate of the table, and the third frame 140 may function as an auxiliary table. Such a structural arrangement enables a compact system configuration, and in a current table having a size of 1800 mm × 1500 mm, up to six RDE measuring systems (e.g., the robot module 300 and the RDE module 400) may designed to be disposed in parallel, thereby greatly improving measurement efficiency.

In some embodiments, a sample holder 210 may be disposed on the main frame 110. The sample holder 210 may be positioned near a side surface of the main frame 110. Specifically, the sample holder 210 may be disposed near a guide rail 322 of a robot transfer device 320, which will be described later, and may be installed at a position where the robot arm 310 may easily access. The sample holder 210 provides a structured space in which a catalyst sample is accommodated, and may stably store at least one catalyst sample. Such a structure is designed so that a researcher or the robot arm 310 may easily dispose a sample, such as a catalyst sample, in an initial position, and may be configured in a form capable of fixing a container containing the sample at an accurate position.

The sample seating portion 220 according to some embodiments may be a portion in which the catalyst sample accommodated in the sample holder 210 is seated. The sample seating portion 220 may be disposed on the third frame 140. Such a disposition is designed such that a series of processes may be efficiently performed, whereby the robot arm 310 grips the catalyst sample from the sample holder 210, transfers it to the sample seating portion 220, then uses a pipette 340 to aspirate a catalyst droplet of the catalyst sample, and applies it onto an electrode surface of the RDE 410. Specifically, a catalyst sample transferred from the sample holder 210 by a gripper 330 of the robot module 300 may be accurately seated in the sample seating portion 220. The sample seating portion 220 has a structure in which the catalyst sample may be fixed at an accurate position, and this allows the pipette 340 to aspirate a catalyst droplet at a consistent position. In addition, a position of the sample seating portion 220 is optimized in consideration of a distance from the RDE 410, so that the robot arm 310 may aspirate the catalyst droplet and then apply it onto an electrode surface of the RDE 410 with minimal movement.

The robot module 300 according to some embodiments may transfer the catalyst sample. The robot module 300 may include the robot arm 310, the robot transfer device 320, the gripper 330, and the pipette 340.

The robot arm 310 according to some embodiments may be implemented in a form of a collaborative robot having a multi-joint structure to perform works at various angles and positions. As illustrated in FIG. 5 and the like, the robot arm 310 is configured with a plurality of joint portions and links, and thereby may freely move in a three-dimensional space. The robot arm 310 may be configured to be communicable with the control device 30 and may be controlled by a Python-based program, so as to ensure precise position control and accuracy of repetitive operations.

A robot transfer device 320 according to some embodiments may transfer the robot arm 310. The robot transfer device 320 may include a guide rail 322 and a motor 324. The guide rail 322 may be linearly installed on the main frame 110, and allow a base mounted on a lower portion of the robot arm 310 to linearly move along the guide rail 322. The motor 324 may provide a driving force that moves the base of the robot arm 310 along the guide rail 322. The robot transfer device 320 provides a linear movement range of up to 1,250 mm, so as to allow the robot arm 310 to move across an entire frame 100. Such a configuration greatly scales up a relatively limited working radius of the robot arm 310, and allows a single robot arm 310 to access various positions within the automated device 10 for electrochemical property evaluation, such as the sample holder 210, the sample seating portion 220, the RDE 410, and the like. The robot transfer device 320 is controlled by Python code, and may enable movement and stop at accurate positions, thereby significantly improving precision and efficiency of the entire automated system.

The gripper 330 according to some embodiments may be a device mounted at an end of the robot arm 310 and capable of gripping or manipulating various objects. With reference to FIG. 6 and the like, the gripper 330 may be configured with a body connected to the robot arm 310 and a finger portion capable of gripping an object. The gripper 330 may operate in an electrically driven manner, and may be configured to precisely control an opening and closing degree of the fingers. In particular, the gripper 330 may be configured to perform a work of gripping and picking up a catalyst sample from the sample holder 210 and transferring it to the sample seating portion 220. The finger portion of the gripper 330 may fix the catalyst sample with an appropriate pressure so as to minimize damage to the catalyst sample, and may position the catalyst sample at an accurately designated position through precise position control.

The pipette 340 according to some embodiments may be mounted at an end of the robot arm 310 to be disposed at one side of the gripper 330. In some embodiments, the pipette 340 may be installed so as not to overlap with the gripper 330. The pipette 340 may accurately aspirate and discharge a catalyst droplet within the catalyst sample. The pipette 340 may be configured to allow precise, micro-scale aspiration and discharge manipulation, and to control an aspiration and discharge speed of a liquid, thereby uniformly applying the catalyst droplet onto an electrode surface. The pipette 340 may be used in combination with a disposable tip. Although not illustrated, the disposable tip may be positioned on the third frame 140. That is, the disposable tip may be disposed at a position adjacent to the sample holder 210. Such a disposable tip may be automatically mounted at the beginning of a property evaluation experiment to prevent cross-contamination between samples, and may be replaced as needed. For example, after the gripper 330 seats a catalyst sample in the sample seating portion 220, the pipette 340 may be configured to combine with the disposable tip positioned on the third frame 140, and may aspirate the catalyst droplet within the catalyst sample seated in the sample seating portion 220 with an accurate amount, and apply it onto the electrode surface of the RDE 410. The pipette 340 is an automated electronic pipette communicable with the control device 30, and may be controlled by a Python-based program. For example, the pipette 340 may be initialized by an initialize function, and may be controlled by various functions that may precisely control a liquid aspiration amount, an aspiration speed, a discharge speed, and the like.

The robot arm 310, the robot transfer device 320, the gripper 330, and the pipette 340 of the above-described robot module 300 organically operate, and significantly contribute to automation and improvement in precision of the entire system. In particular, a combination of the robot arm 310 and the robot transfer device 320 enables precise position control while securing a wide working space, and a combination of the gripper 330 and the pipette 340 enables continuous work performing from the transfer of the catalyst sample to the application of the catalyst droplet.

The RDE module 400 according to some embodiments may measure and analyze electrochemical properties of a catalyst. The RDE module 400 according to some embodiments may include an RDE 410, an RDE driving unit 420, a cell 430, a cell supply unit 440, a cell discharge unit 450, an inspection unit 460, a drying unit 470, a moisture supply unit 480, a first cleaning unit 491, and a second cleaning unit 492.

The RDE 410 according to some embodiments may be a rotating disk electrode. The RDE 410 may be a disk-formed electrode rotating about a central axis, and may act as a working electrode. The RDE 410 may have a structure in which a disk made of a conductive material, such as glassy carbon or platinum, is inserted in an insulator, such as Teflon or polyetheretherketone (PEEK). An electrode surface of the RDE 410 is a key portion where electrochemical reactions occur, and a state of the electrode surface and uniformity of an applied catalyst droplet directly affect measurement results. The RDE 410 may rotate at a predetermined speed during electrochemical measurement, and may contribute to measuring a diffusion limiting current and measuring and analyzing a reaction mechanism by controlling substance transfer in an electrolyte.

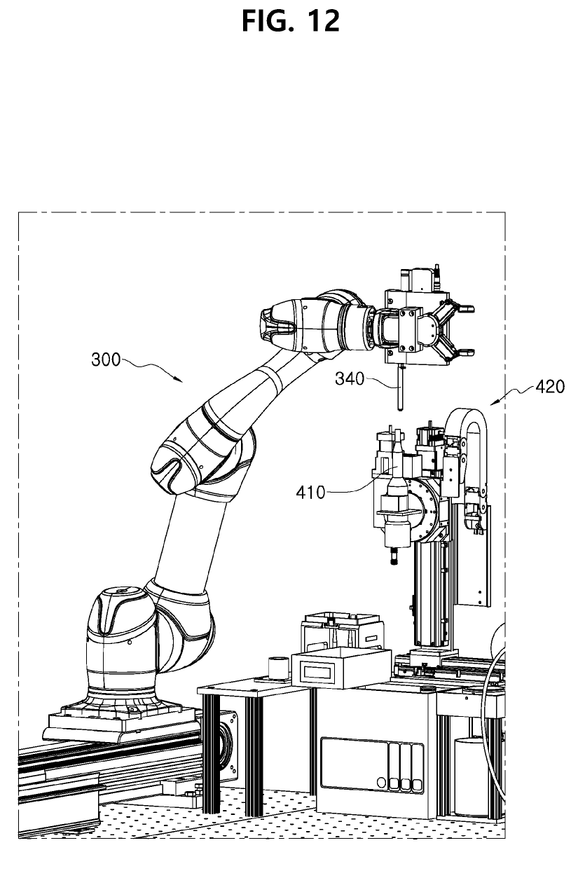

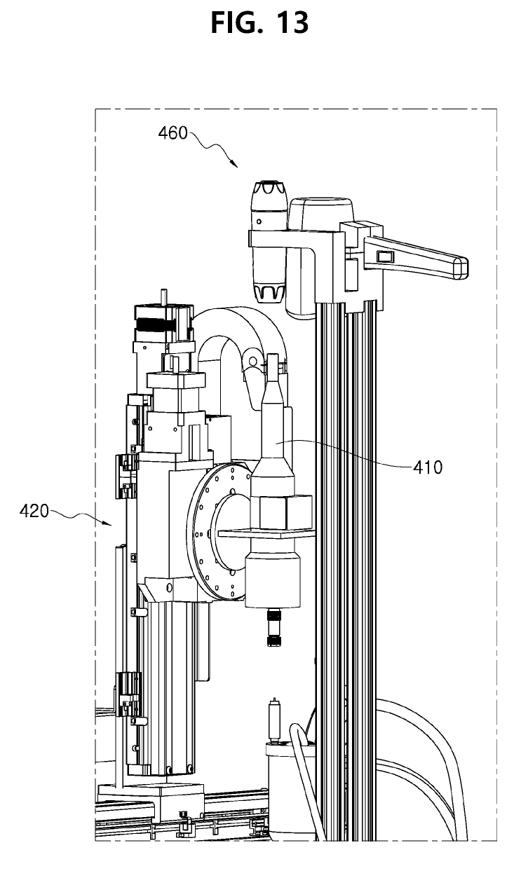

The RDE driving unit 420 according to some embodiments may move the RDE 410. With reference to FIGS. 7 and 8, and the like, the RDE driving unit 420 may be configured as a three-axis actuator that may move the RDE 410 in X-axis, Y-axis, and R-axis (rotation) directions. The RDE driving unit 420 may be communicable with the control device 30, and may be controlled by a Python-based program. In particular, the RDE driving unit 420 may move the RDE 410 to various positions within the automated device 10 for electrochemical property evaluation with accuracy. Specifically, the RDE driving unit 420 may move the RDE 410 to positions respectively corresponding to a position facing the pipette 340 (droplet application position, see FIG. 12), a position inserted into the cell 430 (measurement position), the inspection unit 460, the drying unit 470, the moisture supply unit 480, the first cleaning unit 491, and the second cleaning unit 492 (see FIGS. 13 and 17-21). That is, as illustrated in FIG. 8, the RDE driving unit 420 may move the RDE 410 along a movement path M. Such multi-axis movement and rotation functions of the RDE driving unit 420 play a key role in automating all processes such as electrode preparation, measurement, cleaning, and the like. The RDE driving unit 420 is controlled with high precision using a step motor, and movement paths to respective positions are optimized by the control device 30 to ensure an efficient work sequence.

The cell 430 according to some embodiments may be a container in which electrochemical measurement is performed. With reference to FIGS. 9 and 10, and the like, the cell 430 may be a container made of glass or chemical-resistant material in which electrolyte is accommodated, and inside of which the RDE 410, which is a working electrode, a counter electrode 431, and a reference electrode 432 may be disposed. That is, a three-electrode system may be configured in an interior of the cell 430. The counter electrode 431 according to some embodiments may be an electrode that provides a path through which current flows during an electrochemical reaction. The counter electrode 431 may be disposed to maintain an appropriate distance from the RDE 410 in the interior of the cell 430, in order to ensure uniform current distribution through the electrolyte. When a potential difference occurs between the RDE 410, which is a working electrode, and the counter electrode 431, current flows through the electrolyte, and the current is directly related to an electrochemical reaction on a surface of the RDE 410. The reference electrode 432 according to some embodiments may be an electrode that provides a reference point for accurate potential measurement. The reference electrode 432 may be configured to maintain a stable potential and to have a property such that almost no current flows during the measurement.

According to some embodiments, a potentiostat, which is the current measuring device 20, may accurately control and monitor a potential difference between the RDE 410, which is a working electrode, and the reference electrode 432. In this process, the reference electrode 432 provides a stable reference point with almost no current flow, and simultaneously, the current measuring device 20 measures current between the RDE 410 and the counter electrode 431. As a result, while accurately controlling a potential applied to the RDE 410, a current response corresponding thereto may be precisely measured. Meanwhile, while the RDE 410 rotates, substances in the electrolyte may be consistently supplied to an electrode surface by centrifugal force. This generates a substance transfer mechanism in which convection and diffusion are combined, thereby enabling measurement under steady-state conditions. By controlling a rotation speed of the RDE 410, a substance transfer speed may be adjusted, and various electrochemical properties may be analyzed and evaluated.

Meanwhile, a cover is disposed on an upper end of the cell 430, and a hole having a diameter of approximately 20 mm may be formed at a central portion of the cover. Through the hole of the cover, the RDE 410 may be inserted, and a plurality of small holes (having a diameter of approximately 7 mm) for electrodes, gas, and electrolyte injection may be formed around the inserted RDE 410. On a side surface of the cell 430, a side surface outlet fluidly communicating with an excess liquid outlet portion 451 described later may be formed. At a bottom of the cell 430, a bottom outlet fluidly communicating with a waste liquid outlet portion 452 described later may be formed.

As illustrated in FIGS. 9 and 10, and the like, the cell supply unit 440 according to some embodiments may supply electrolyte, deionized water (DI water), and gas into the cell 430. The cell supply unit 440 may include a first pump 441, a second pump 442, and a flow controller 443.

The first pump 441 according to some embodiments may be a pump that supplies electrolyte into the interior of the cell 430. In addition, the first pump 441 may be configured to be communicable with the control device 30 and may transfer a predetermined amount of electrolyte into the interior of the cell 430. That is, the first pump 441 is controlled by a Python-based program and may accurately supply electrolyte into the cell 430 according to a predetermined flow rate. In addition, the second pump 442 may supply deionized water for cleaning the interior of the cell 430. In addition, the flow controller 443 may supply measurement gas into the interior of the cell 430. For example, the flow controller 443 may supply argon (Ar) gas into the interior of the cell 430. In some embodiments, the flow controller 443 may be a mass flow controller (MFC). The flow controller 443 may also be configured to be communicable with the control device 30 and may be controlled based on Python. In some other embodiments, it is obvious that, depending on experimental conditions or design conditions, a type of electrolyte or a type of gas may be changed, and a pump or flow controller may be additionally installed as needed.

The cell discharge unit 450 according to some embodiments may discharge liquid, gas or the like in the interior of the cell 430. The cell discharge unit 450 may include an excess liquid outlet portion 451 and a waste liquid outlet portion 452. The excess liquid outlet portion 451, as described above, may be configured to fluidly communicate with a side surface outlet of the cell 430, and when the electrolyte rises at a predetermined level or higher, it may be automatically discharged to consistently maintain an electrolyte level in the interior of the cell 430.

The waste liquid outlet portion 452 may discharge used electrolyte and the like. The waste liquid outlet portion 452 may be configured to fluidly communicate with a bottom outlet of the above-described cell 430. The waste liquid outlet portion 452 may have a tube made of Teflon that may be connected to the bottom outlet using an Ultra Torr connector. In addition, a valve 453 may be installed on the tube of the waste liquid outlet portion 452, and the valve 453 may be a solenoid valve. Whether to discharge electrolyte or the like in the interior of the cell 430 may be determined by opening or closing of the valve 453. The valve 453 may be controlled by Python code through a power box, and may be opened when the electrolyte in the interior of the cell 430 is removed during a cleaning process after measurement is completed.

The inspection unit 460 according to some embodiments may verify a state of catalyst droplet applied to the electrode surface of the RDE 410. Specifically, the inspection unit 460 may visually verify whether a catalyst droplet is properly applied to the electrode surface of the RDE 410. The inspection unit 460 may be configured as a microscope of a USB-based communication type. The inspection unit 460 may communicate with the control device 30 and may be controlled by a Python-based program, and may store and analyze captured images. Detailed description thereof will be provided later.

The drying unit 470 according to some embodiments may dry a catalyst droplet applied to the electrode surface of the RDE 410. Drying of a catalyst droplet may directly affect uniformity and adhesion of a catalyst layer, and therefore may be a very important factor for accuracy and reproducibility of an electrochemical measurement result. The drying unit 470 may be an IR lamp (infrared lamp), but is not limited thereto. The drying unit 470 may be controlled by Python code through a power box, and configured to dry the catalyst droplet on the electrode surface by turning on the IR lamp when power is applied. A drying time and temperature may be precisely controlled by the control device 30, and optimal drying conditions may be set according to various types of catalysts. The drying unit 470 may be fixed together with the inspection unit 460 through aluminum profiles and brackets. Accordingly, the RDE 410 moved by the RDE driving unit 420 may be dried at an accurate position.

The moisture supply unit 480 according to some embodiments may supply moisture to the dried electrode surface. The moisture supply unit 480 may be disposed at a position where moisture may be uniformly supplied to the electrode surface of the RDE 410 that has been moved at an accurate position by the RDE driving unit 420. The moisture supply unit 480 may be configured as a humidifier, but is not limited thereto. The moisture supply unit 480 may also be controlled by Python code through a power box, and when power is applied, the moisture supply unit 480 may operate to supply fine water particles to the electrode surface. Accordingly, appropriate moisture may be supplied to a catalyst layer formed on the electrode surface after drying, which allows a catalyst may to exhibit optimal activity in a subsequent measurement. Meanwhile, a moisture supply time and intensity may be controlled by the control device 30, and may be optimized according to various catalyst types and experimental conditions.

A cleaning unit according to some embodiments may clean the electrode surface of the RDE. The cleaning unit may be configured with a dual cleaning method. Specifically, the cleaning unit may adopt a dual cleaning method including mechanical polishing and ultrasonic cleaning, so as to ensure complete cleaning of the electrode surface of the RDE 410, and to prevent a previous residual catalyst from affecting a result of a next measurement in continuous measurements. In some embodiments, the cleaning unit may include the first cleaning unit 491 and the second cleaning unit 492.

The first cleaning unit 491 according to some embodiments may perform first cleaning of the RDE 410 by polishing the electrode surface of the RDE 410. Specifically, the first cleaning unit 491 may cleanly polish the electrode surface of the RDE 410 after the measurement is completed, in order to completely remove the residual catalyst remaining on the electrode surface, and to provide a clean and uniform surface for application of a new catalyst droplet, thereby preparing it for use in a next measurement. The first cleaning unit 491 may be configured with a rotating polishing pad, a step motor for driving the pad, and a pump for supplying distilled water and polishing liquid. The first cleaning unit 491 may be controlled by Python code, and may precisely control a polishing speed and an injection amount of liquid through adjustment of starting, stopping, and RPM of the motor. An upper end plate of the first cleaning unit 491 may include holes through which liquid may be discharged, and may be designed with a slope to allow used liquid to be automatically discharged.

The second cleaning unit 492 according to some embodiments may perform second cleaning of the RDE 410 using ultrasonic waves. The second cleaning unit 492 may be an ultrasonic cleaner (sonic bath) communicable with the control device 30. In an interior of the second cleaning unit 492, a container (e.g., a Falcon tube) filled with ethanol may be positioned, and the RDE 410 may be immersed in the ethanol and cleaned with ultrasonic waves. The second cleaning unit 492 may be controlled by a Python-based program, and operation time and temperature may be precisely controlled through an operate function. An ultrasonic cleaning process of the second cleaning unit 492 may be performed after a mechanical polishing in the first cleaning unit 491, thereby completely removing fine catalyst particles and contaminants not removed during the polishing process.

Hereinafter, with reference to FIGS. 1-10, a method for measuring and analyzing electrochemical properties of a catalyst using the automated system 1 for electrochemical property evaluation described above will be described in detail. To aid understanding, reference numerals cited from FIGS. 1-10 will be identically cited below.

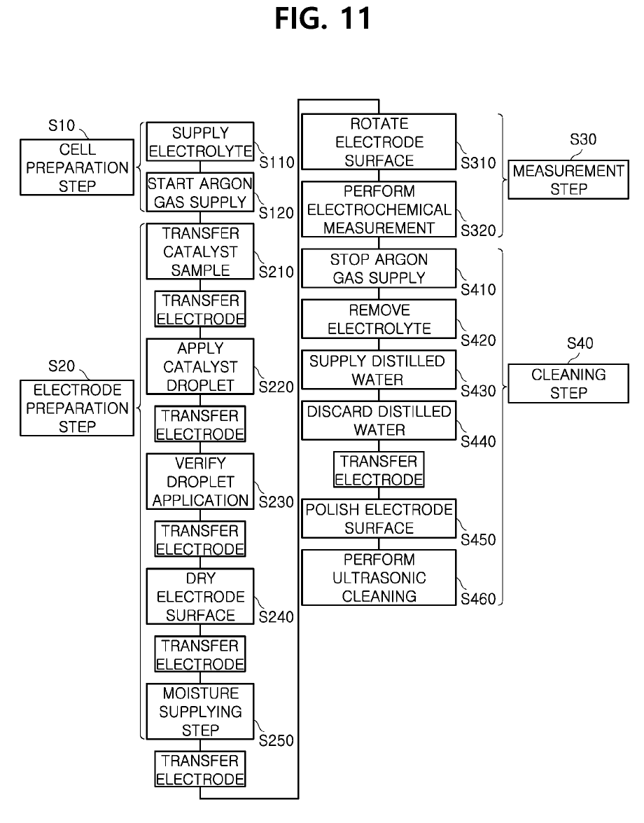

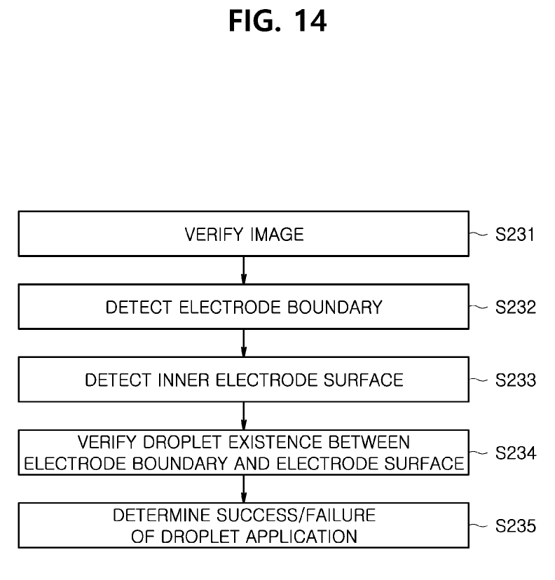

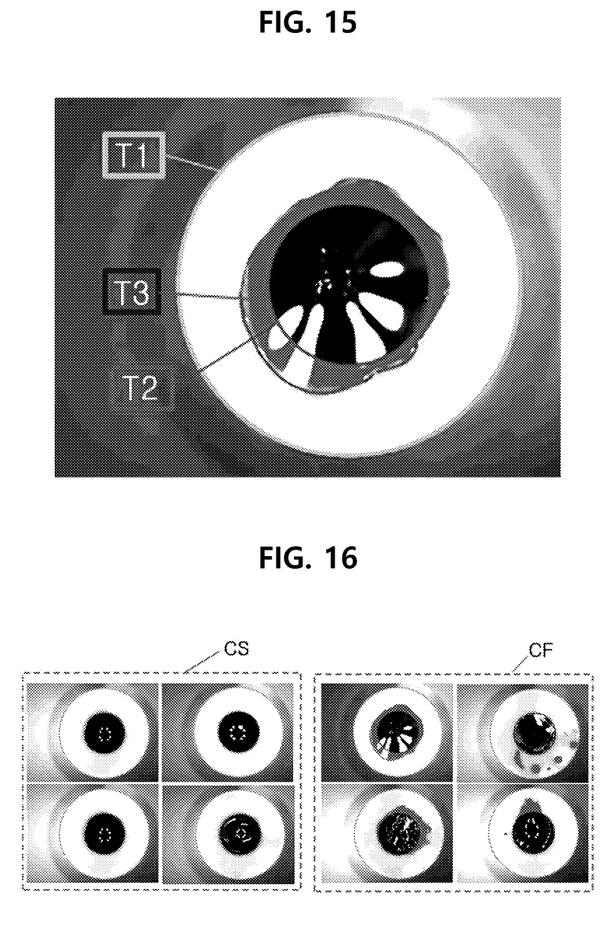

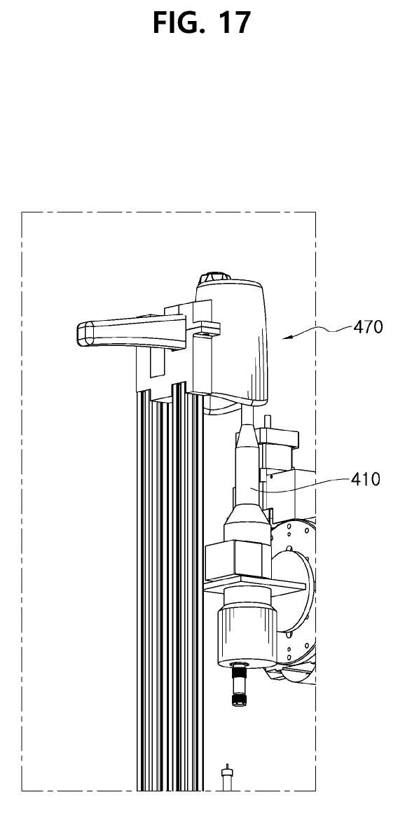

FIG. 11 is a flowchart of a method for measuring electrochemical properties of a catalyst using the automated system for electrochemical property evaluation in FIG. 1. FIGS. 12, 13, and 17-21 are views schematically illustrating states in which respective steps of a method for measuring electrochemical properties of a catalyst are performed. Meanwhile, FIG. 14 is a flowchart illustrating a detailed sequence of image processing and droplet application determination performed in the droplet application verification step, FIG. 15 is a view schematically illustrating an electrode boundary, an inner electrode surface, and a catalyst droplet boundary between the electrode boundary and the inner electrode surface in FIGS. 14, and 16 is views schematically illustrating exemplary states of catalyst droplet application success and failure in the droplet application verification step.

With reference to FIGS. 11-21, a method for measuring electrochemical properties of a catalyst using an automated system for electrochemical property evaluation according to some embodiments (hereinafter, “property measurement method”) may include a cell preparation step S10, an electrode preparation step S20, a measurement step S30, and a cleaning step S40. The cell preparation step S10, the electrode preparation step S20, the measurement step S30, and the cleaning step S40 may be performed in a time-series sequence.

The cell preparation step S10 according to some embodiments may supply an electrolyte into the cell 430, and supply an inert gas such as argon into the interior of the cell 430, thereby removing oxygen and the like in the interior of the cell 430. Specifically, the cell preparation step S10 may include an electrolyte supply step S110 and an argon gas supply start step S120.

The electrolyte supply step S110 according to some embodiments may supply an electrolyte into the cell 430 by using the first pump 441. The first pump 441 may supply the electrolyte into the interior of the cell 430 at a predetermined flow rate, and the electrolyte may be filled up to a predetermined level inside the cell 430. In this case, when the electrolyte is filled up to a level corresponding to the side surface outlet of the cell 430, the electrolyte may be automatically discharged through the excess liquid outlet portion 451, thereby maintaining a predetermined level.

The argon gas supply start step S120 according to some embodiments may supply argon gas into the interior of the cell 430 via the flow controller 443. The argon gas performs a purging function to remove dissolved oxygen in the interior of the cell 430, and this may contribute to minimizing interference due to oxygen in a subsequent electrochemical measurement. The flow controller 443 may supply argon gas to the cell 430 at a precisely controlled flow rate, and this process may be automatically controlled by the control device 30. That is, as described above, the first pump 441 and the flow controller 443 may be controlled by a Python-based program and may be automated.

The electrode preparation step S20 according to some embodiments may include a process of applying a catalyst sample onto the electrode surface of the RDE 410, verifying a state of the applied catalyst droplet, and then drying the electrode surface. Specifically, the electrode preparation step S20 may include a catalyst sample transfer step S210, a catalyst droplet application step S220, a droplet application verification step S230, an electrode surface drying step S240, and a moisture supplying step S250.

In the catalyst sample transfer step S210 according to some embodiments, the robot module 300 may transfer a catalyst sample accommodated in the sample holder 210. The robot arm 310 according to some embodiments may grip and pick up a catalyst sample positioned in the sample holder 210 by using the gripper 330. Thereafter, the robot arm 310 may move via the robot transfer device 320, and may transfer the catalyst sample to the sample seating portion 220. The catalyst sample may be stably seated on the sample seating portion 220, and may be fixed at an accurate position such that the sample may be aspirated by the pipette 340 in a subsequent step.

In the catalyst droplet application step S220 according to some embodiments, a catalyst droplet is aspirated from the catalyst sample by using the pipette 340, and the droplet may be then applied onto the electrode surface of the RDE 410. As illustrated in FIG. 12, the robot arm 310 may use the pipette 340 attached to the gripper 330 to first combine with a disposable tip positioned on the third frame 140, and may aspirate a predetermined amount of catalyst droplet from the catalyst sample seated on the sample seating portion 220. In this case, the RDE driving unit 420 may move the RDE 410 to a catalyst droplet application position, as illustrated in FIG. 12. That is, the RDE driving unit 420 may move the RDE 410 to a position where the electrode surface of the RDE 410 may face the pipette 340. As a result, the catalyst droplet aspirated into the pipette 340 may be precisely applied to the electrode surface of the RDE 410. The pipette 340 may be controlled by a Python-based program so that an accurate volume of the catalyst droplet is discharged at a uniform speed and is uniformly applied onto the electrode surface.

In the droplet application verification step S230 according to some embodiments, a state of the catalyst droplet applied onto the electrode surface of the RDE 410 may be visually verified using the inspection unit 460. As illustrated in FIG. 13, the RDE driving unit 420 may move the RDE 410, on which the catalyst droplet has been applied, to a position corresponding to the inspection unit 460. That is, the RDE driving unit 420 may move the RDE 410 to a position where the electrode surface of the RDE 410 may face the inspection unit 460, that is, a microscope. The inspection unit 460 may capture an image of the catalyst droplet applied to the electrode surface, and the captured image may be analyzed by the control device 30.

In some embodiments, in the droplet application verification step S230, the processing of the captured image and the determination as to whether the catalyst droplet has been normally applied may be performed through a detailed sequence. Specifically, as illustrated in FIG. 14, a detailed sequence in the droplet application verification step S230 may be sequentially performed, including image verification S231, electrode boundary detection S232, inner electrode surface detection S233, verification of the presence or absence of a droplet between the electrode boundary and the electrode surface S234, and the determination of success or failure of the droplet application S235.

As illustrated in FIG. 15, in the droplet application verification step S230, the electrode boundary T1, the inner electrode surface T2, and the catalyst droplet boundary T3 between the electrode boundary and the inner electrode surface may be sequentially detected from the captured image (S231 to S234). In some embodiments, the electrode boundary T1 may represent an outermost boundary of the RDE 410. The inner electrode surface T2 may represent an actual active region of the electrode where the catalyst droplet is to be applied. The droplet boundary T3 may represent a boundary of the catalyst droplet applied onto the electrode surface, and whether this boundary is properly formed may be an important criterion for determining whether applying of the catalyst droplet succeeds. The control device 30 may detect each boundary through an image processing algorithm, and may determine whether the catalyst droplet is uniformly applied within the inner electrode surface T2, whether the catalyst droplet has overflowed outside the electrode boundary T1, or the like (S235).

As illustrated in FIG. 16, in the droplet application verification step S230, an example of droplet application success CS and an example of droplet application failure CF may be distinguished. In some embodiments, in case of droplet application success CS, it may represent a case where the catalyst droplet is uniformly distributed within the inner electrode surface, and does not overflow outside the electrode boundary. Various images illustrated in the left region in FIG. 16 illustrate successful application examples in which the catalyst droplet is completely applied onto the inner electrode surface and forms a uniform surface. In contrast, the images illustrated in the right region in FIG. 16 illustrate examples of droplet application failure CF, in which case the catalyst droplet flows over the electrode boundary, is non-uniformly distributed on the inner electrode surface, bubbles are formed, or the like.

In some embodiments, when the control device 30 determines, through image processing, that the catalyst droplet application has failed (e.g., in case of droplet application failure CF), the RDE 410 may be moved to perform an electrode surface polishing step S450 and/or an ultrasonic cleaning step S460, which will be described later, and may be automated to repeat again from the droplet application step S220 after the cleaning. This provides the automated system 1 for electrochemical property evaluation with the capability to detect and correct errors on its own, thereby enabling consistent analysis of the electrochemical properties of the catalyst without researcher intervention. On the other hand, when it is determined that the catalyst droplet application succeeds (e.g., in case of droplet application success CS), the process may proceed to the subsequent step, which is the electrode surface drying step S240.

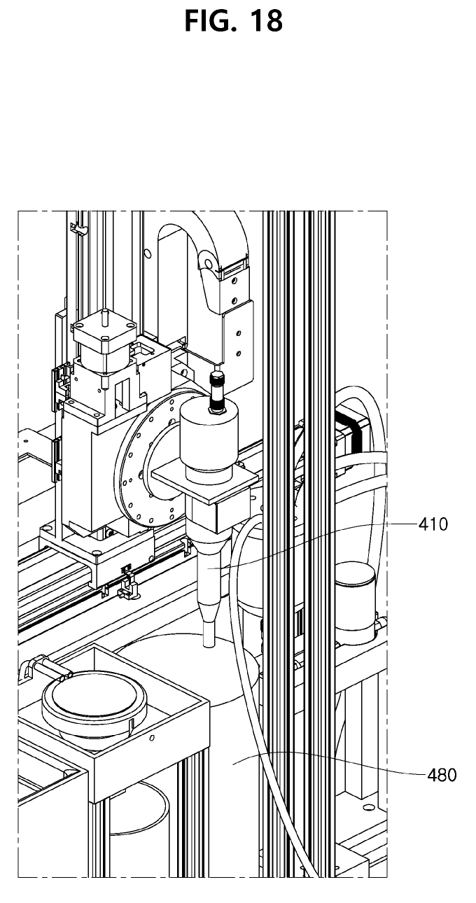

In the electrode surface drying step S240 according to some embodiments, the applied catalyst droplet may be dried. As illustrated in FIG. 17, the RDE driving unit 420 may move the RDE 410 to a position corresponding to the drying unit 470. Specifically, the RDE driving unit 420 may position the electrode surface of the RDE 410 to be adjacent and facing the drying unit 470, particularly the IR lamp. The IR lamp may operate to efficiently dry the catalyst droplet applied onto the electrode surface. The drying time and temperature may be precisely controlled by the control device 30, and optimized drying conditions may be applied depending on the type of catalyst and the amount of the catalyst droplet, such that a uniform catalyst layer is formed on the electrode surface. Although not illustrated, in some other embodiments, a step of verifying whether the catalyst droplet on the electrode surface of the RDE 410 has been properly dried may additionally be performed after the electrode surface drying step S240. Such an additional verification step may be performed by the inspection unit 460, in the same manner as the previously described droplet application verification step S230.

In the moisture supplying step S250 according to some embodiments, appropriate moisture may be supplied to the dried electrode surface. As illustrated in FIG. 18, the RDE driving unit 420 may move the RDE 410, for which drying has been completed, to a position corresponding to the moisture supply unit 480. The moisture supply unit 480 may uniformly spray fine water particles onto the electrode surface, supplying an appropriate level of moisture to the dried catalyst layer. The moisture supply time and intensity may be controlled by the control device 30, and may be optimized according to various catalyst types and experimental conditions so that the catalyst may exhibit optimal activity in the subsequent electrochemical measurement.

In the measurement step S30 according to some embodiments, the electrochemical properties of the catalyst may be measured and evaluated while rotating the RDE 410 positioned in the interior of the cell 430. Specifically, the measurement step S30 may include an electrode surface rotation step S310 and an electrochemical measurement step S320.

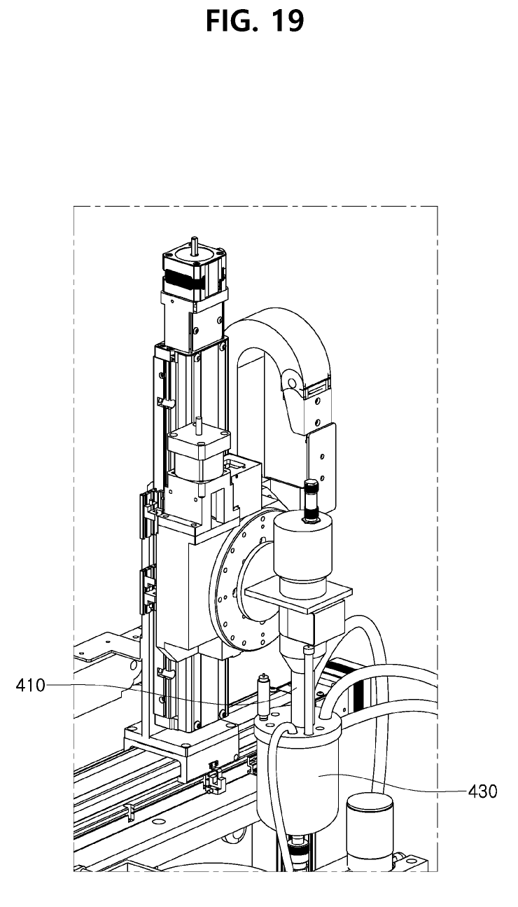

In the electrode surface rotation step S310 according to some embodiments, the RDE 410 may be rotated at a predetermined speed. As illustrated in FIG. 19, the RDE driving unit 420 may move the RDE 410 to a position to be inserted into the interior of the cell 430. Specifically, the RDE driving unit 420 may perform R-axis rotation and XY-axis movement such that the RDE 410 is inserted into the interior of the cell 430 through the hole formed at a central upper end portion of the cell 430. Thereafter, the RDE rotor included in the current measuring device 20 may be controlled by the control device 30 to rotate the RDE 410 at a preset RPM. The rotation speed may be set variously depending on the measurement conditions, and may be set within the range of 400 RPM to 2500 RPM such that a stable diffusion layer is formed by controlling substance transport in the electrolyte. Through this, a diffusion limiting current may be measured and the mechanism of the electrochemical reaction may be analyzed.

In the electrochemical measurement step S320 according to some embodiments, the electrochemical properties for the catalyst may be measured using the current measuring device 20. The measurement may be performed while the RDE 410 is rotating inside the cell 430, and various electrochemical techniques may be applied. For example, techniques such as cyclic voltammetry (CV), linear sweep voltammetry (LSV), and chronoamperometry (CA) may be used. The current measuring device 20 may accurately control the potential difference between the RDE 410 and the reference electrode 432, and simultaneously measure the current between the RDE 410 and the counter electrode 431. The potential-current relation data measured in this process may be stored in JSON format, and may be used to evaluate properties such as electrochemical activity, stability, selectivity, and the like of the catalyst.

As previously described, the current measuring device 20 may be controlled by Python code using a development package, store measurement parameters and protocols in JSON format, and operate based thereon. The measurement parameters may include various settings such as applied voltage range, scan rate, number of repetitions, data sampling rate, and the like. These parameters may be optimized according to the properties of the catalyst to be measured and the reaction conditions. In addition, the current measuring device 20 may collect and process the data generated during the measurement in real time, thereby ensuring the accuracy and reliability of the measurement results.

The supply of argon gas initiated in the argon gas supply start step S120 may be continuously maintained throughout the entire process of the measurement step S30, thereby performing a role of preventing oxygen from introducing into the interior of the cell 430. Through this, the pure properties of the catalyst may be accurately measured without interference due to oxygen.

The cleaning step S40 according to some embodiments may perform preparing for a subsequent measurement by cleaning the electrode surface of the RDE 410 and the cell 430 after the measurement step S30 is completed. Specifically, the cleaning step S40 may include an argon gas supply stop step S410, an electrolyte removal step S420, a distilled water supply step S430, a distilled water discard step S440, an electrode surface polishing step S450, and an ultrasonic cleaning step S460.

In the argon gas supply stop step S410 according to some embodiments, the supply of argon gas through the flow controller 443 may be stopped. The argon gas supply stop step S410 may be performed when the protective environment in the interior of the cell 430 is no longer necessary after the measurement step S30 is completed. The flow controller 443 may be controlled via Python-based instructions such as a stopDevice function, so that the gas supply may be safely stopped.

In the electrolyte removal step S420 according to some embodiments, the electrolyte in the interior of the cell 430 may be removed through the waste liquid outlet portion 452. Specifically, the valve 453 may be opened to allow the used electrolyte and the like in the interior of the cell 430 to be discharged through the waste liquid outlet portion 452. The valve 453 may be a solenoid valve, and it may be controlled by Python code through a power box, so that the point in time and speed of discharging the electrolyte may be precisely controlled.

In the distilled water supply step S430 according to some embodiments, deionized water (DI water) may be supplied into the interior of the cell 430 using the second pump 442. This process may be for washing out the electrolyte and impurities remained in the interior of the cell 430, and the second pump 442 may supply deionized water into the interior of the cell 430 at a predetermined flow rate. The distilled water supply step S430 may clean the interior of the cell 430 thoroughly, thereby preventing contamination caused by previous electrolyte or by-products during subsequent measurements.

In the distilled water discard step S440 according to some embodiments, the distilled water in the interior of the cell 430 may be discarded through the waste liquid outlet portion 452. Similarly to the electrolyte removal step S420, the valve 453 may be opened to allow the distilled water in the interior of the cell 430 to be discharged through the waste liquid outlet portion 452. In this case, the distilled water supply step S430 and the distilled water discard step S440 may be repeatedly performed multiple times, thereby allowing the interior of the cell 430 to be perfectly cleaned.

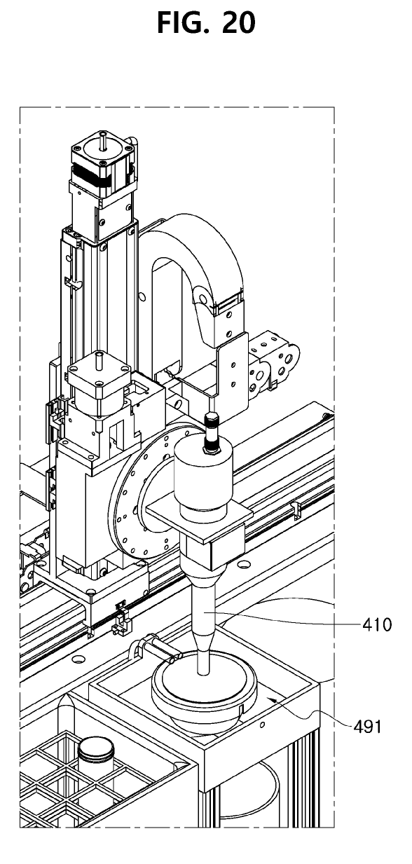

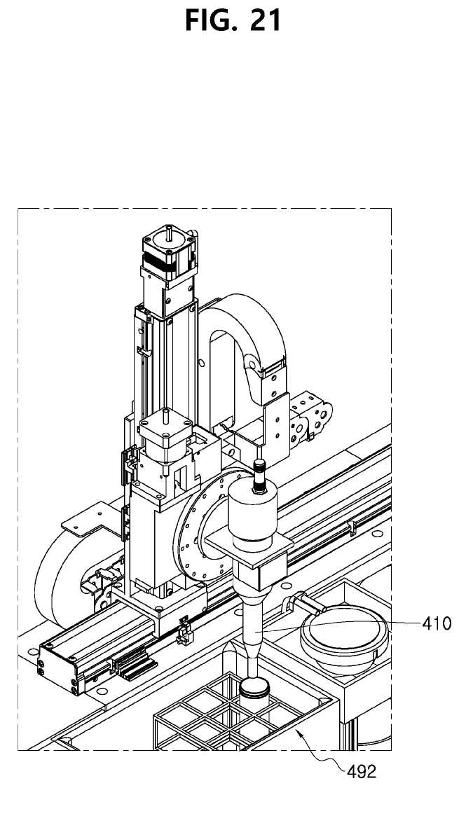

In the electrode surface polishing step S450 according to some embodiments, the electrode surface of the RDE 410 may be mechanically polished, thereby removing residual catalyst remaining on the surface and performing first cleaning. As illustrated in FIG. 20, the RDE driving unit 420 may move the RDE 410 to a position corresponding to the first cleaning unit 491. That is, the RDE driving unit 420 may move the RDE 410 to a position where the electrode surface of the RDE 410 may come into contact with the polishing pad of the first cleaning unit 491. The first cleaning unit 491 may clean the electrode surface of the RDE 410 through a rotating polishing pad. The polishing pad is driven by a step motor, and during the polishing process, distilled water and polishing liquid may be supplied through a pump. The electrode surface polishing step S450 may completely remove all residual catalyst and contaminants remaining on the electrode surface, so as to prepare a clean and uniform surface for subsequent measurements. Polishing time, rotation speed, and liquid supply rate may be precisely controlled by the control device 30, and may be set to achieve optimal cleaning results.

In the ultrasonic cleaning step S460 according to some embodiments, the RDE 410 may be additionally subjected to second cleaning through ultrasonic cleaning. As illustrated in FIG. 21, the RDE driving unit 420 may move the RDE 410 to a position corresponding to the second cleaning unit 492. That is, the RDE driving unit 420 may insert the RDE 410 into an interior (e.g., a container) of the second cleaning unit 492. The second cleaning unit 492 may be an ultrasonic cleaner, and the electrode surface of the RDE 410 may be immersed in a container (e.g., Falcon tube) filled with ethanol, and may be cleaned with ultrasonic waves. The ultrasonic cleaning may even remove fine impurities and contaminants that were not removed in the electrode surface polishing step S450, thereby allowing the electrode surface to be perfectly cleaned. The operation time and temperature of the ultrasonic cleaner may be precisely controlled through the operate function, and this may be automated by a Python-based program.

In some embodiments, after the cleaning step S40 is completed, the automated system 1 for electrochemical property evaluation may restart from the cell preparation step S10 for the next measurement. Alternatively, as needed, it may restart from the electrode preparation step S20. Such a cyclic automation process is highly efficient for continuously measuring multiple samples, and may stably operate over a long period of time without the intervention of the researcher.

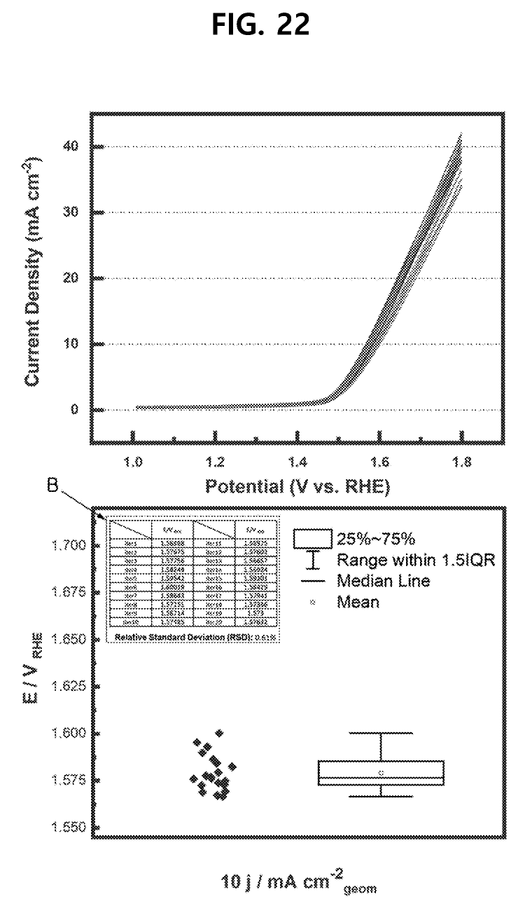

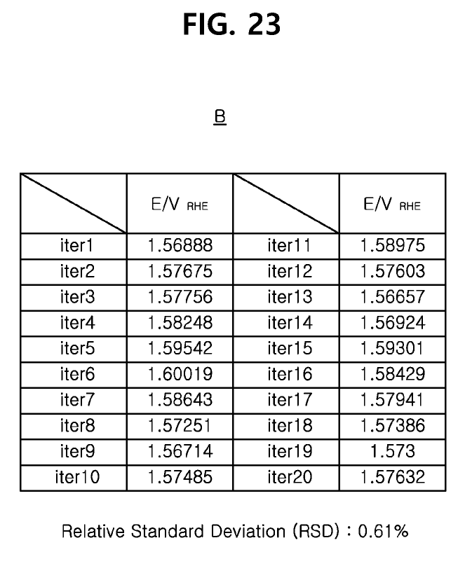

FIGS. 22 and 23 illustrate the reproducibility when the electrochemical properties of a catalyst were measured using the automated system 1 for electrochemical property evaluation.

As a result of testing the catalyst performance of Ir Black, a commercial catalyst, 20 times consecutively, the average value of the potential measured at a current density of 10 mA/cm² was 1.5792 V, and the relative standard deviation (RSD) was 0.61%, showing very high reproducibility. This proves that the automated system 1 for electrochemical property evaluation of the present invention can accurately measure the properties of the catalyst in a consistent manner.

The above detailed description is for the purpose of illustrating the present invention. Further, the foregoing description merely shows and describes the exemplary embodiments of the present disclosure, and the present disclosure can be used in various other combinations, modifications, and environments. That is, alterations or modifications may be made within the scope of the concept of the invention disclosed in the present specification, the scope equivalent to the described disclosure, and/or the scope of the technology or knowledge in the art. The disclosed embodiments are provided to explain the best state for implementing the technical teachings of the present disclosure, and various modifications required for the specific fields of application and the use of the present disclosure may be made. Thus, the detailed description of the present disclosure is not intended to limit the present disclosure to the disclosed embodiments. Moreover, the appended claims should be construed to include other embodiments.

### DESCRIPTION OF REFERENCE NUMERALS

1: Automated system for electrochemical property evaluation
10: Automated device for electrochemical property evaluation
20: Current measuring device
30: Control device
100: Frame
300: Robot module
310: Robot arm
320: Robot transfer device
330: Gripper
340: Pipette
400: RDE module
410: RDE
420: RDE driving unit
430: Cell
440: Cell supply unit
450: Cell discharge unit
460: Inspection unit
470: Drying unit
480: Moisture supply unit
491: First cleaning unit
492: Second cleaning unit

What is claimed is:

1. An automated system for electrochemical property evaluation for analyzing electrochemical properties of a catalyst, the automated system comprising:
a robot module configured to transfer a catalyst sample and to aspirate and apply a catalyst droplet;
an RDE module including a rotating disk electrode (RDE) and an RDE driving unit configured to move the RDE;
an inspection unit configured to visually verify a state of the catalyst droplet applied onto an electrode surface of the RDE; and
a control device configured to control the robot module, the RDE module, and the inspection unit, by a Python-based program, wherein the control device is configured to:
process an image captured by the inspection unit to determine whether applying of the catalyst droplet succeeds; and
when the applying fails, control the robot module and the RDE module to reattempt the applying of the catalyst droplet.

2. The automated system of claim 1, wherein the RDE driving unit comprises a three-axis actuator configured to move the RDE in X-axis, Y-axis, and rotation (R) axis directions.

3. The automated system of claim 2, further comprising:
a frame on which the robot module, the RDE module, and the inspection unit are installed, wherein the frame is configured such that additional components are installed in parallel.

4. The automated system of claim 3, wherein the RDE driving unit is configured to move the RDE to a plurality of specific positions corresponding to each of:
a pipette included in the robot module; and
a cell, the inspection unit, a drying unit, a moisture supply unit, a first cleaning unit, and a second cleaning unit, which are disposed on the frame.

5. The automated system of claim 4, wherein
among the specific positions,
a position corresponding to the pipette is a position where the electrode surface of the RDE is disposed to face the pipette, and the catalyst droplet is applied from the pipette,
a position corresponding to the cell is a position where the RDE is inserted into an interior of the cell and an electrochemical measurement is performed,
a position corresponding to the inspection unit is a position where the electrode surface of the RDE is disposed to face a microscope of the inspection unit, and an applied state of the catalyst droplet is captured, and
a position corresponding to the drying unit is a position where the electrode surface of the RDE is disposed to face an IR lamp of the drying unit and the catalyst droplet is dried.

6. The automated system of claim 4, wherein
among the specific positions,
a position corresponding to the moisture supply unit is a position where the electrode surface of the RDE is disposed to face the moisture supply unit and moisture is supplied to the dried electrode surface,
a position corresponding to the first cleaning unit is a position where the electrode surface of the RDE is disposed to come into contact with a polishing pad of the first cleaning unit and the electrode surface is mechanically polished, and
a position corresponding to the second cleaning unit is a position where the RDE is inserted into a container filled with ethanol in the second cleaning unit and ultrasonic cleaning is performed.

7. The automated system of claim 4, wherein the control device is configured to control the RDE driving unit by the Python-based program so as to sequentially move the RDE between the specific positions.

8. The automated system of claim 1, wherein the control device is configured to detect an electrode boundary, an inner electrode surface, and a catalyst droplet boundary between the electrode boundary and the inner electrode surface in an image captured by the inspection unit, and to determine whether the catalyst droplet is uniformly applied within the inner electrode surface.

9. The automated system of claim 1, wherein the RDE module further comprises:
a cell in which an electrolyte is accommodated and in which the RDE, a counter electrode, and a reference electrode are disposed;
a cell supply unit configured to supply the electrolyte, deionized water, and gas to the cell; and
a cell discharge unit configured to discharge a liquid or gas in an interior of the cell.

10. The automated system of claim 1, wherein the RDE module further comprises:
a drying unit configured to dry the catalyst droplet applied onto the electrode surface of the RDE;
a moisture supply unit configured to supply moisture to the dried electrode surface;
a first cleaning unit configured to perform first cleaning by polishing the electrode surface of the RDE; and
a second cleaning unit configured to perform a second cleaning of the RDE with ultrasonic waves.

11. A method for measuring electrochemical properties of a catalyst, comprising:
an electrode preparation step in which a robot arm transfers a catalyst sample accommodated in a sample holder to a sample seating portion, and aspirates a catalyst droplet within the catalyst sample via a pipette disposed on the robot arm, and a rotating disk electrode (RDE) is moved by an RDE driving unit to a position facing the pipette so that the pipette applies the catalyst droplet onto an electrode surface of the RDE;
a droplet application verification step in which the RDE driving unit moves the RDE to a position facing an inspection unit, the inspection unit captures an image of the catalyst droplet applied to the electrode surface of the RDE, and determines whether the catalyst droplet is normally applied from the captured image;
an electrode surface drying step in which the RDE driving unit moves the RDE to a position facing a drying unit, and the drying unit dries the catalyst droplet applied onto the electrode surface of the RDE;
a moisture supplying step in which the RDE driving unit moves the RDE to a position facing a moisture supply unit, and the moisture supply unit supplies moisture to the dried electrode surface of the RDE;
a measurement step in which the RDE driving unit moves the RDE to a position inserted into an interior of a cell, and electrochemical measurement of the catalyst is performed using a current measuring device while rotating the RDE; and
a cleaning step in which the RDE driving unit moves the RDE to positions respectively corresponding to a first cleaning unit and a second cleaning unit, the first cleaning unit mechanically polishes the electrode surface of the RDE, and the second cleaning unit cleans the electrode surface of the RDE with ultrasonic waves.

12. The method of claim 11, wherein the droplet application verification step comprises:
detecting an electrode boundary from the captured image;
detecting an inner electrode surface inside the electrode boundary;
verifying whether a droplet boundary exists between the electrode boundary and the inner electrode surface; and
determining whether the droplet application succeeds or fails based on positional relationships among the electrode boundary, inner electrode surface, and droplet boundary.

13. The method of claim 11, wherein, when a droplet application failure is determined in the droplet application verification step, the RDE driving unit moves the RDE to the first cleaning unit or the second cleaning unit, and the electrode preparation step is performed again after cleaning.

14. The method of claim 11, further comprising:
prior to the measurement step,
an electrolyte supply step of supplying an electrolyte to the cell using a first pump; and
an argon gas supply start step of supplying argon gas into the interior of the cell using a flow controller.

15. The method of claim 11, further comprising:
after the measurement step,
an argon gas supply stop step of stopping a supply of argon gas through a flow controller;
an electrolyte removal step of removing the electrolyte in the interior of the cell through a waste liquid outlet portion;
a distilled water supply step of supplying deionized water into the interior of the cell using a second pump; and
a distilled water discard step of discarding the distilled water in the interior of the cell through the waste liquid outlet portion.

16. The method of claim 11, wherein the robot arm, the RDE driving unit, the inspection unit, the drying unit, the moisture supply unit, the first cleaning unit, and the second cleaning unit are communicably connected to a control device, and are controlled by a Python-based program.
